(19) United States
(12) Patent Application Publication
(10) Pub. No.: US 2023/0004620 A1
(43) Pub. Date: Jan. 5, 2023

(54) PAGE DISPLAY METHOD

(71) Applicant: BEIJING DAJIA INTERNET INFORMATION TECHNOLOGY CO., LTD., Beijing (CN)

(72) Inventor: Sheng Liu, Beijing (CN)

(21) Appl. No.: 17/898,683

(22) Filed: Aug. 30, 2022

Related U.S. Application Data
(63) Continuation of application No. PCT/CN2020/141043, filed on Dec. 29, 2020.

(30) Foreign Application Priority Data
Apr. 29, 2020 (CN) 202010358294.0

(51) Int. Cl. G06F 16/957; G06F 16/958; G06F 40/14

(52) U.S. Cl. CPC G06F 16/9577; G06F 16/958; G06F 40/14

(57) ABSTRACT

A page display control method includes: receiving a first page display instruction; displaying a reference page stored in the first client; sending a first page content to a webpage control in response to receiving a page acquisition request sent by the webpage control, in which the first page content represents a webpage interactive content that is interactive with the first client in the first page, acquiring a first page view by the webpage control through integration according to a first page frame view and the first page content, and returning information that page rendering is finished by the webpage control; and hiding the reference page and displaying the first page view in response to receiving the information that the page rendering is finished.

### CROSS-REFERENCE TO RELATED APPLICATION

The present application is a continuation of International Application No. PCT/CN2020/141043, filed on Dec. 29, 2020, which claims priority to Chinese Patent Application 202010358294.0, filed on Apr. 29, 2020, the entire disclosures of which are incorporated herein by reference.

### FIELD

The present disclosure relates to a technical field of page processing, and more particularly to a page display control method, an electronic device and a storage medium.

### BACKGROUND

In general, in a case where a page (such as a HTML 5 page, i.e., an H5 page for short) needs to be displayed, processes such as file loading and rendering are performed, and a corresponding page content is displayed thereafter. However, during the process of the file loading and rendering, a client interface shows a blank/white page, and this will make webpages display discontinuously. How to effectively avoid the blank/white page phenomenon in the page display and control process and ensure continuity of the page display has become an urgent problem to be solved.

### SUMMARY

According to a first aspect of the present disclosure, a page display control method applied to a first client is provided. The method includes: receiving a first page display instruction; displaying a reference page stored in the first client; sending a first page content to a webpage control in response to receiving a page acquisition request sent by the webpage control, in which the first page content represents a webpage interactive content that is interactive with the first client in the first page, acquiring a first page view by the webpage control through integration according to a first page frame view and the first page content, and returning information that page rendering is finished by the webpage control; and hiding the reference page and displaying the first page view in response to receiving the information that the page rendering is finished.

According to a second aspect of the present disclosure, an electronic device is provided. The electronic device includes a processor, and a memory for storing instructions executable by the processor. The processor is configured to execute the instructions to perform the above-mentioned page display control method.

According to a third aspect of the present disclosure, a non-transitory computer-readable storage medium is provided. The non-transitory computer-readable storage medium has stored therein instructions that, in response to being executed by a processor of a client, cause the client to perform the above-mentioned page display control method.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure, and do not constitute an improper limitation of the present disclosure.

FIG. 1 is a schematic diagram showing an application environment of a page display control method according to an embodiment.

FIG. 2 is a flow chart of a page display control method according to an embodiment.

FIG. 3 is a schematic diagram showing a relationship between a general page and a sub-page according to an embodiment.

FIG. 4 is a schematic diagram showing integration of a page frame view and a page content according to an embodiment.

FIG. 5 is a schematic diagram showing a relationship between a general page and a sub-page according to another embodiment.

FIG. 6 is a schematic diagram showing a relationship between a general page and a sub-page according to still another embodiment.

FIG. 7 is a flow chart of a page display control method according to another embodiment.

FIG. 8 is a block diagram of a page display control apparatus according to an embodiment.

FIG. 9 is a schematic diagram showing an internal structure of a server according to an embodiment.

### DETAILED DESCRIPTION

In order to make those skilled in the art better understand the technical solutions of the present disclosure, the technical solutions in embodiments of the present disclosure will be described clearly and completely below with reference to the accompanying drawings.

It should be noted that the terms “first” and “second” in the specification, the claims and the accompanying drawings of the present disclosure are used to distinguish similar objects, but are not necessary to indicate a specific order or sequence. It should be understood that the terms so used may be interchangeable where appropriate, such that embodiments of the present disclosure described herein may be implemented in a sequence other than those illustrated or described herein. The embodiments described in the following illustrative examples are not intended to represent all embodiments consistent with the present disclosure. On the contrary, they are merely examples of apparatus and methods consistent with some aspects of the present disclosure as recited in the appended claims.

In technical solutions provided by some embodiments of the present disclosure, once a first client receives a first page display instruction, it displays a pre-stored reference page. In this way, the first client will not display a blank page on a screen. The first client triggers a webpage control to perform page view rendering to acquire a first page frame view. In response to receiving a page acquisition request, a first page content is sent to the webpage control. A first page view is acquired by the webpage control through integration according to the first page frame view and the first page content. The first client withdraws the reference page and displays the first page view once information that the page rendering is finished sent by the webpage control is received by the first client. In the above-mentioned technical solutions, the reference page stored in the first client is displayed without loading the reference page, which avoids the blank page on the screen, and ensure the continuity of the page display.

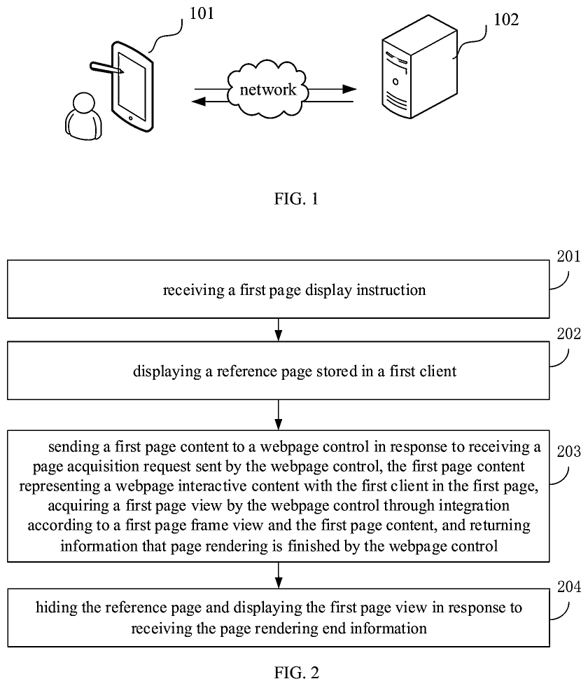

The page display control method provided in the present disclosure may be applied in an application environment shown in FIG. 1. The application environment includes a first client 101 and a webpage control 102. The first client 101 is communicated with the webpage control 102 through a network. The first client 101 may be, but is not limited to, various terminals. Further, the first client 101 may refer to an application program installed in the above-mentioned terminal devices. The webpage control 102 may be implemented by a terminal device or a server, or may be a browser or a webpage container provided on the terminal device or the server, and it may process webpage information and control the output and display of the webpage. The terminal device may be a personal computer, a laptop, a smartphone, a tablet and a portable wearable device. The server may be implemented by an independent server or a server cluster composed of multiple servers.

FIG. 2 is a flow chart of a page display control method according to an embodiment. As shown in FIG. 2, the page display control method is applied to a first client. The page display control method includes the following operations.

In S201, a first page display instruction is received.

In S202, a reference page stored in the first client is displayed.

The first page display instruction may be an instruction for triggering the display of the first page, and contain an identification parameter of the first page, which allows the first client to know which page is currently targeted upon receiving the first page display instruction. The first page display instruction may be a click triggering instruction received by an interface of the first client. For example, a link address of the first page is displayed on the interface of the first client, a user clicks the link address, and the webpage control receives click information, that is, receives the first page display instruction. The first page may be a page corresponding to a webpage in a format such as hypertext markup language (HTML). Specifically, the first page may be a page corresponding to HTML5. In some embodiments, the first page may be referred to as a general page.

The reference page may be a preset dynamic page, static page, a picture and so on. In a case where the reference page is the dynamic page, it may be called as a loading animation, and having various contents, which are not limited by the present disclosure. Further, the reference page may be in a graphics interchange format (GIF). Further, the reference page may be a native animation in the first client, that is, stored in an internal storage of the first client.

In some embodiments, the first page display instruction may be sent to the first client by the webpage control once the webpage control receives the triggering information that the user triggers the first page.

In S203, a first page content is sent to the webpage control in response to receiving a page acquisition request sent by the webpage control. The first page content represents a webpage interactive content that is interactive with the first client in the first page. A first page view is acquired by the webpage control through integration according to the first page frame view and the first page content, and information that page rendering is finished is returned by the webpage control.

In some embodiments, the first page view may be simply referred to as a first page.

The page acquisition request may be sent by the webpage control after acquiring the first page frame view, or may be sent by the webpage control in a case where a page rendering instruction is received and it is determined that the first page content is not stored in the webpage control.

The first page content may refer to the webpage interactive content uploaded by the user to a server-side, and the server-side may be a server for publishing and maintaining a first webpage and a second webpage. The webpage interactive content may be an article, a picture, a video, a post, a microblog comment and other media information. In addition, the first page content may also refer to information uploaded by a web developer to the server through the client, which may be a company profile, product information for sale, and the like. After displaying the first page view on the interface of the first client, an interactive operation of the above-mentioned webpage interactive content may be triggered through clicking on a display screen by the user. For example, the user clicks a video icon to play the video, or the user clicks a comment box below a microblog to enter a comment. In some embodiments, the first client may also acquire the first page content through a way other than the server, for example, directly acquire the pre-stored first page content from the internal storage.

The first page view may refer to a view that needs to be displayed in response to displaying the first page, which may be a picture, an animation or a video. In this operation, the first page frame view and the first page content are integrated by the webpage control to acquire the first page view, and the information that the page rendering is finished is generated after acquiring the first page view and this information is returned to the first client. The information that the page rendering is finished may include the first page view. The webpage control may also return the information that the page rendering is finished to the first client first, and then return the first page view to the first client.

Further, the webpage control may send the information that the page rendering is finished to the first client in response to a preset page hiding instruction being triggered. Alternatively, the webpage control may directly return the information that the page rendering is finished to the first client once acquiring the first page view.

In S204, the reference page is hidden and the first page view is displayed in response to receiving the information that the page rendering is finished.

In this operation, after receiving the first page view by the first client, the currently displayed reference page is directly hidden and the first page view is displayed. The client may also hide the reference page and display the first page view under the condition that the preset page hiding instruction is triggered. In some embodiments, the first client may first receive the information that the page rendering is finished sent by the webpage control to remove the reference page accordingly, and then receive the first page view sent by the webpage control and display the first page view.

In addition, the first client does not need to hide or withdraw the reference page, it may directly overlay the first page view above the reference page, such that the first page view is finally displayed by the first client to the user.

Before displaying a page, the webpage control needs to perform preprocesses, such as loading a page file and rendering the page. In a traditional page display process, during these preprocesses, the first client interface is in a blank screen state, resulting in a discontinuous display of the webpage and a poor user experience. In the page display control method of the above-mentioned embodiments, the first client may display the reference page in response to receiving the first page display instruction, such that the webpage control may display the corresponding reference page on the first client during the preprocess of the first webpage. In addition, the reference page is pre-stored in the first client and does not need to be loaded, in this way the reference page can be displayed immediately, thereby ensuring the continuity of the page display and avoiding psychological pressure on the user.

In some embodiments of the present disclosure, in a case where codes need to be updated, the codes may be updated at any time without a review process of an application store, and thus may be launched in a short time, which improves an update efficiency of the codes in the case the codes need to be updated, and ensures the continuity of the page display. In some embodiments of the present disclosure, it does not need to acquire the reference page from an APP package file, and thus an acquisition speed is fast and the reference page can be quickly displayed, which greatly shortens a display time of the blank page on the screen and further ensures the continuity of the page display.

In some embodiments, acquiring the first page view through the integration according to the first page frame view and the first page content may be implemented in at least the following ways:

1. the first page content is filled into a webpage frame corresponding to the first page frame view;
2. in a case where the first page content is in a form of a page view, the first page content may be directly overlaid on the first page frame view.

Further, in a case where the page content fits in the webpage frame, the operation of returning the first page content to the webpage control to trigger the webpage control to acquire the first page view through the integration according to the first page frame view and the first page content includes: returning the first page content to the webpage control to trigger the webpage control to fill the first page content into the webpage frame of the first page frame view to acquire the first page view.

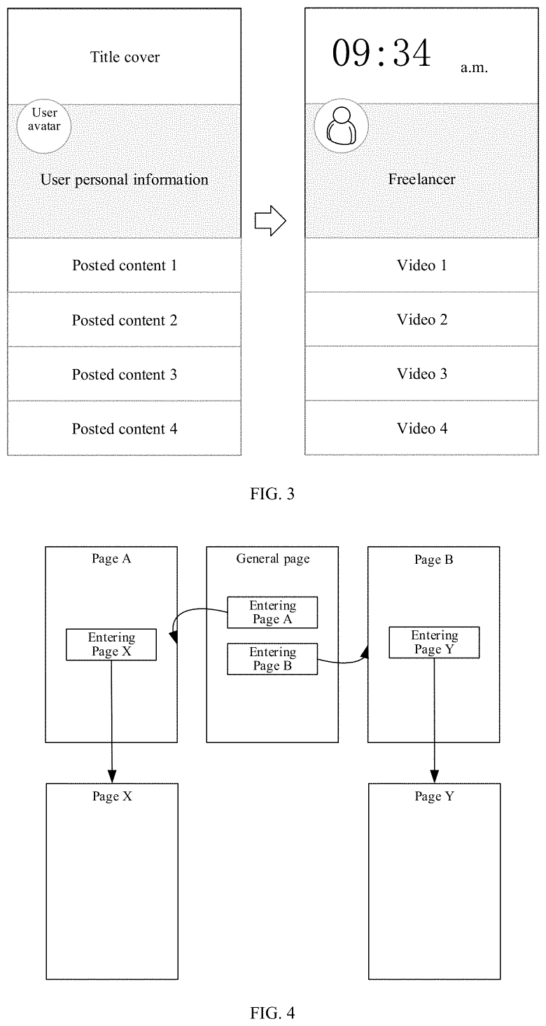

For example, as shown in FIG. 3, a left sub-diagram of FIG. 3 is a schematic diagram showing a first page frame view, which presents positions, area sizes, colors corresponding to different page contents, such as a title cover, a user avatar, user personal information, a published content on an interface. For example, a background element color corresponding to a webpage element of the user personal information is gray. A right sub-diagram of FIG. 3 is a schematic diagram showing a first page view acquired after filling the first page content to the first page frame view. As shown in the right sub-diagram of FIG. 3, each position in the webpage frame is filled with the corresponding page content. The user may perform an interactive operation by clicking on the display screen of the first client, such as clicking an icon corresponding to “Video 1”, to enable the first client to play a content of Video 1 on the interface.

In some embodiments, in a case where there is a sub-page (i.e., a second page) corresponding to the first page, a second page view of the second page may be preloaded during the display of the first page view. That is, the second page view is loaded before a second page display instruction is received, and thus the second page view may be immediately sent to the first client in response to receiving the second page display instruction.

Further, after it is determined that the first page has been displayed in the first client, the first client may control the webpage control to load relevant information of the second page. For example, a process of acquiring, parsing and rendering a second description file of second rendering information is completed, that is, visual codes of the second page is loaded, and the second page view is acquired. In responding to that the second page display instruction is received, the second page view is sent to the first client, and the first client is controlled to display the second page view, thereby switching the first page view to the second page view in the first client.

In addition, in some embodiments, it is also possible to preload a part of information of the second page, such as a second page frame view. In response to receiving the second page display instruction, a complete second page view is loaded according to the preloaded part of information, and the second page view is sent to the first client. Further, after hiding the reference page and displaying the first page view in response to receiving the information that the page rendering is finished sent by the webpage control, the page display control method further includes: trigging the webpage control to acquire the second description file of second rendering information corresponding to the second page based on the presence of the second page corresponding to the first page, parsing the second description file to acquire second page rendering information, performing page view rendering according to the second page rendering information to acquire the second page frame view, acquiring a second page content from the server in response to receiving the second page display instruction, triggering the webpage control to acquire the second page view by integration according to the second page frame view and the second page content, and displaying the second page view. The second page is a sub-page of the first page, and the second page frame view represents a webpage frame of the second page. The second page content represents a webpage interactive content that is interactive with the first client in the second page. The second page display instruction is generated once the second page is triggered. In some embodiments, the second page view may also be referred to as a second page.

The second page is the sub-page of the first page, and thus the second page may be referred to as a specific page. In this case, the second page may also have a corresponding specific page, and the specific page of the second page may have its own specific pages, and so on. In addition, the number of the second pages (including the sub-pages of the second page) may be one, two, or even more. Further, the second page may also be a page corresponding to HTML webpage, such as a page corresponding to HTML5.

The second page display instruction may refer to an instruction for triggering the display of the second page. In some embodiments, the second page display instruction may be sent to the first client by the webpage control upon receiving trigger information that the user triggers the second page.

The second page frame view is generated during the first client displaying the first page view. Further, during displaying the first page, the webpage control is triggered by the first client to perform the page rendering to acquire the second page frame view, and is triggered to generate the second page view according to the second page content once the second page display instruction is received.

As shown in FIG. 4, there are two sub-pages (i.e., Page A and Page B) corresponding to a general page. The first client interface displays keys of “entering Page A” and “entering Page B”. In a case where the key of “entering Page A” is triggered, the first client interface will display Page A, and Page A has a corresponding sub-page, i.e., Page X. Further, in a case where a key of “entering Page X” on the page A is triggered, Page X is displayed on the first client interface. The display processes of Page B and its sub-page, i.e., Page Y are similar, which are not elaborated here.

In addition, the second description file of the second rendering information refers to a file for describing the rendering information of the webpage, which may contain page rendering information, specifically, may contain information such as elements, element shapes, element positions, and element colors that need to be included in the page. Further, the second description file may be an HTML, file, specifically, an HTML5 file. The second page content may be similar to the first page content, except that the two are contents to be displayed on different webpages. In addition, the integration of the second page frame view and the second page content may refer to the integration of the first page frame view and the first page content, which will not be elaborated here.

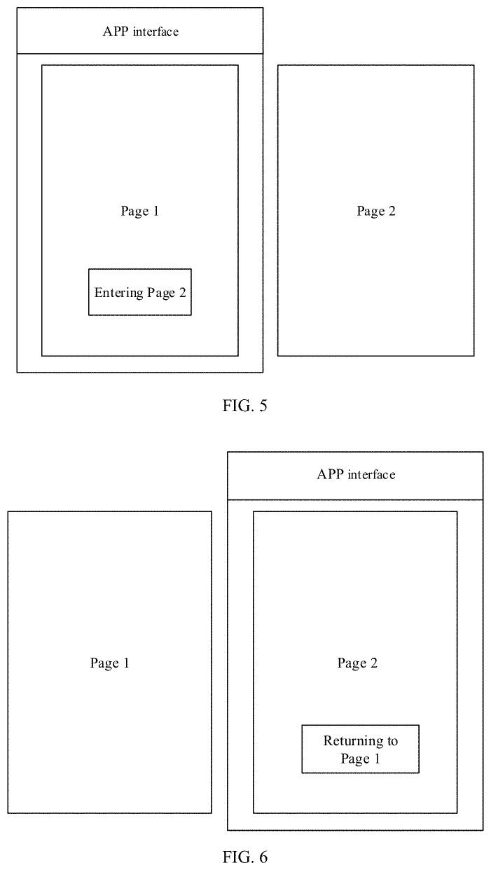

In the page display control method provided by some embodiments of the present disclosure, in a case where the webpage control determines that the first client displays the first page view and the second page display instruction is not received, the second description file is first acquired, and then is parsed and rendered to acquire the second page frame view. As shown in FIG. 5, Page 1 is displayed on an APP interface (i.e., the interface of the first client), the webpage control loads a sub-page, i.e., Page 2 of Page 1 in the background. Specifically, a webpage frame of Page 2 may be loaded. In a case where the second page display instruction is received, for example a key “entering Page 2” is triggered as shown in FIG. 5, the webpage control acquires the second page content from the server through the first client to acquire the second page view, and controls the first client to display the second page view.

In some embodiments, the number of the second pages may be more than one. During the display of the first page, loading all second pages will use relative large amount of the memory of the webpage control. In this case, only some of the second pages may be loaded. Specifically, the part or individual of the second pages to be loaded may be determined in practice. A tentative way of opening a sub-page refers to fitting N sub-pages of a page in N new webviews, respectively, and rendering them in advance. In response to one of the sub-pages being visited, corresponding data is requested and acquired from a common gateway interface (CGI), and the data is filled in the page. In this way, the sub-page may be opened without the blank page on the screen during jumping between the H5 pages, thereby improving a transition effect.

In some embodiments, the first client displays the second page, and the first page information may still be retained, such that the first page may be quickly restored to be displayed again in response to triggering the first page display instruction. As shown in FIG. 6, in a case where Page 2 is displayed on the APP interface, the webpage control continues to load Page 1 in the background, and once the key of “returning to Page 1” is triggered, the first client is controlled to display Page 1.

In some embodiments, in a case where the rendering process of the second page frame view is not finished/completed when the second page display instruction is received by the webpage control, the reference page may be acquired from an internal storage control of the first client, and the first client is controlled to display the reference page on the interface. Alternatively, it may be also possible to continuously display the first page view until the rendering of the second page frame view is completed, thereby ensuring the continuity of the page display.

In addition, the second page frame view may be sent to the first client by the webpage control, and the second page frame view is displayed by the first client. Further, the webpage control acquires the second page content from the server through the first client, and the first client fills the second page content in the interface to complete the display of the second page view.

In some embodiments, the operation of acquiring the second page content from the server in response to receiving the second page display instruction includes: acquiring the second page content from the server in response to receiving the second page display instruction and the second page content being not stored in the webpage control.

In a case where the first client receives the second page display instruction, and it is determined that the second page content is stored in neither the local terminal nor the webpage control, the second page content is acquired from the server. The first client may directly communicate with the server to acquire the corresponding first page content from the server. In some embodiments, the first page content may be acquired directly from the server by the webpage control.

In a case where it is determined that the second page content is stored in the local end, the second page content may be directly sent to the webpage control without acquiring the second page content from the server.

In the above-mentioned embodiments, the second page content is acquired through the first client in an appropriate manner, which may ensure that the webpage control timely completes the generation of the second page view.

In some embodiments, a process of acquiring the second page content may be the same as the process of acquiring the second page content, which will not be elaborated here.

In some embodiments, the operation of acquiring the second page content from the server includes: invoking a common gateway interface of the server to acquire through the common gateway interface the second page content uploaded to the server by a second client.

The common gateway interface (CGI) is a specification of an external program during a web server operating, and a program coded according to CGI may extend the function of the server. The first page content may be uploaded by the second client to the server through the CGI, and the server may store the first page content in a database. An invoking instruction is sent to the CGI of the server by the webpage control, the server acquires the corresponding first page content from the database according to the calling instruction, and return the content to the webpage control. In some embodiments, acquiring the first page content from the server through the CGI may also be directly referred to as acquiring CGI data for short.

In addition, the number of the second clients may be one, two or even more. Further, the first client and the second client may be the same client, or may be different clients.

In some embodiments, the operation of displaying the reference page stored in the first client in response to receiving the first page display instruction includes: acquiring the pre-stored reference page from the internal storage in response to receiving the first page display instruction, and displaying the reference page. The reference page is at least one of a dynamic page and a static page.

The internal storage may be a memory, a magnetic disk and so on. In some embodiments, the reference page is directly stored in the internal storage of the first client. In this way, in a case where the reference page needs to be displayed, the reference page may be directly acquired, and does not need to be acquired from an APP code package, which is not affected by an APP launching review time, thereby improving the code update efficiency. In addition, the temporary reference page is displayed during loading the first page view, and thus the page display has a better continuity, thereby improving interactive performance of the terminal with the user.

In some embodiments, the operation of sending the page rendering instruction to the webpage control includes: sending the page rendering instruction to the webpage control to trigger the webpage control to acquire a first description file of first rendering information corresponding to the first page, parsing the first description file to acquire first page rendering information, and performing page view rendering according to the first page rendering information to acquire the first page frame view.

The first description file is similar to the second description file, and may be an HTML file, specifically, an HTML5 file (which may be referred to as H5 for short). After parsing the HTML file, the method may further include an operation of loading webpage information. The webpage information may be CSS, Javascript and pictures. The webpage view may be rendered according to the webpage information.

Specifically, the first page frame view may be acquired by the following operations.

1. A webview is initialized.

2. An HTML5 file corresponding to an H5 link is loaded by the webview.

3. The HTML5 file is parsed by the webview.

4. CSS, Javascript and pictures embedded in the HTML5 file are loaded by the webview.

5. A page view is rendered by the webview according to CSS, Javascript and pictures to acquire a first page frame view. In a case where it is browser-side rendering, the view needs to be rendered again according to Javascript.

In the above-mentioned embodiments, in response to receiving the first page display instruction, the reference page is displayed on the interface by the first client. At the same time, the webpage control is controlled to perform page rendering to acquire the first page frame view, and further acquires the first page view through the integration according to the first page frame view and the first page content, and the first client is controlled to close the reference page and display the first page on the interface, which may ensure the continuity of the webpage display and quickly display of the first page.

In some embodiments, at a moment when the operation of loading the HTML document of H5 by webview is completed, the webview may send the information that the page rendering is finished to the client, and the loading view is hidden after the client receives the message. At this moment, different strategies may be formulated according to different scenarios.

Further, the page display control method further includes: receiving the information that the page rendering is finished sent by the webpage control based on that one of the following conditions is satisfied: loading a static resource of the first page is completed; an interactive input interface is activated; the interactive input interface is configured to receive interaction information input by the first client; the first page content is acquired; a preset delay time is reached.

The static resource may refer to information in a form of a text and a picture such as the page frame, of the first page.

The activation of the interactive input interface means that the first client can receive the interactive information of the user and the first client can send the interactive information to the webpage control through the interactive input interface.

Acquiring the first page content may refer to receiving the first page content returned by the server.

The preset delay time may be determined according to a network state of the first client. In a case where the network state is good, the delay time can be a relatively short time. Specifically, the delay time may be 50 ms or 100 ms.

In addition, in response to that at least one of the above-mentioned conditions is satisfied, the webpage control may send an animation hiding instruction to the first client to control the first client to close the reference page, and then send the first page view to the first client to allow the first client to display the first page view accordingly.

FIG. 7 is a flow chart of a page display control method according to an embodiment. As shown in FIG. 7, the page display control method includes the following operations.

1. In a case where a client receives an instruction of opening a general page (a user clicks an H5 link on a client interface), a webview (a webpage control) is started and initialized.

2. A loading view container is covered on the current client interface to display a reference page.

3. The webview is used to load a HTML file corresponding to the H5 link, parse the HTML file, load CSS, Javascript and pictures embedded in the HTML file, and render the view to acquire a first page frame view.

4. A first page content is acquired from a server by the webview.

5. The first page content is filled into a webpage frame of the first page frame view by the webview to acquire a first page view.

6. In response to that the client receives the information that the page rendering is finished from the webview, the loading view container is hidden and the first page view is displayed.

7. The webview traverses sub-pages of the first page to determine the sub-page(s) as a second page. A HTML file corresponding to the sub-page (the second page) is loaded, the HTML file is parsed, CSS, Javascript and pictures embedded in the HTML file are loaded, and view rendering is performed to acquire a second page frame view.

8. Once the webview receives a second page display instruction, a signal is sent to the client to entrust the client to request CGI data (i.e., the second page content). In this case, request parameters (if any), such as identification information of the second page, are also be sent.

9. The client first determines whether the webview is in a foreground, that is, whether it is currently displayed. In a case where it is in the foreground, it further determines whether there is CGI data of the H5 in the webview. In a case where there is the data, no operation needs to be performed.

10. In a case where there is no data, a CGI data request is sent to the server.

11. The server returns the CGI data to the webview.

12. The webview fills the CGI data into the webpage frame of the second page frame view to acquire a second page view.

13. The webview controls the client to hide the first page view and display the second page view.

In the page display control method provided by the present disclosure, the reference page is displayed during loading the page view, and the second page is loaded in advance, which may improve the transition effect during jumps between the H5 pages and improve the user experience. In addition, the H5 page is flexible in nature, and the codes may be updated at any time without the review process of the application store, resulting in a short launching time and a high efficiency.

It should be understood that although the operations in the flow charts of FIGS. 2 and 7 are presented sequentially with the arrows, these operations are not necessarily executed in the order indicated by the arrows. Unless explicitly stated herein, the execution of these operations is not strictly limited to the order, and the operations may be executed in other orders. Moreover, at least a part of the operations in FIGS. 2 and 7 may include multiple operations or stages, and these operations or stages are not necessarily executed at the same time, but may be executed at different moments. These operations or stages are not necessarily executed in sequence, but may be performed in cycle or alternately with other operations or at least a part of operations or stages in the other operations.

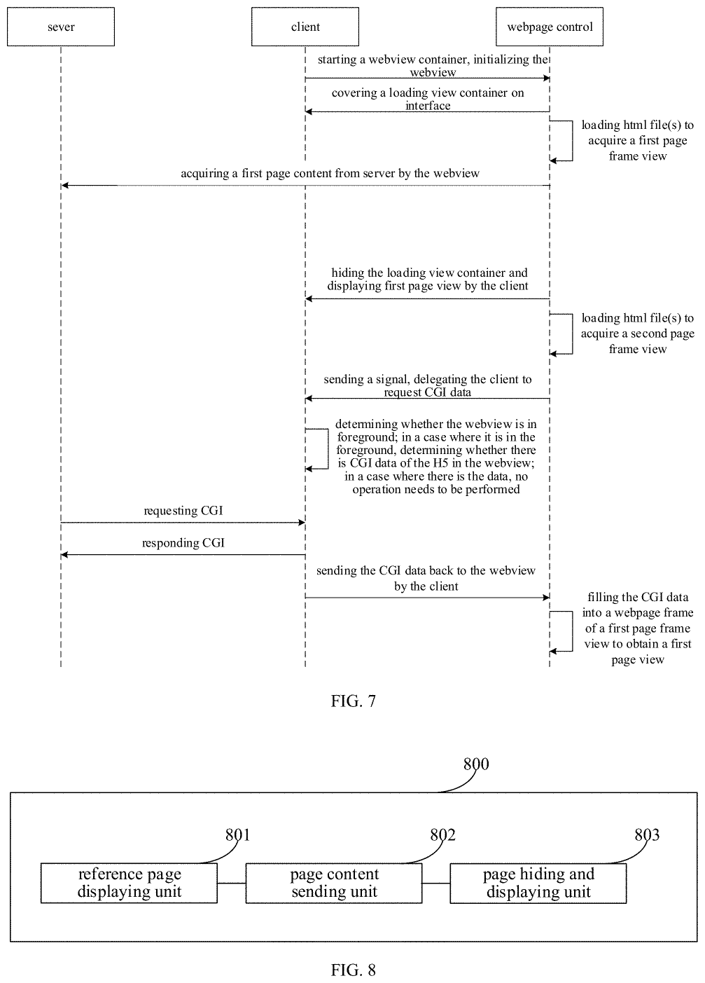

FIG. 8 is a block diagram of a page display control apparatus according to an embodiment of the present disclosure. Referring to FIG. 8, the page display control apparatus includes a reference page displaying unit 801, a page content sending unit 802 and a page hiding and displaying unit 803.

The reference page displaying unit 801 is configured to receive a first page display instruction, and display a reference page stored in the first client.

The page content sending unit 802 is configured to send a first page content to a webpage control in response to receiving a page acquisition request sent by the webpage control, acquire a first page view by the webpage control through integration according to a first page frame view and the first page content, and return information that page rendering is finished by the webpage control. The first page content represents a webpage interactive content that is interactive with the first client in the first page.

The page hiding and displaying unit 803 is configured to hide the reference page and display the first page view in response to receiving the information that the page rendering is finished returned by the webpage control.

In the above-mentioned page display control apparatus, once the first client receives the first page display instruction, it displays the pre-stored reference page. In this way, the first client will not display the blank page on the screen, thus improving the continuity of the page display. The first client triggers the webpage control to perform page view rendering to acquire the first page frame view. In response to receiving the page acquisition request, the first page content is sent to the webpage control. A first page view is acquired by the webpage control through integration according to the first page frame view and the first page content. The first client withdraws the reference page and displays the first page view once information that the page rendering is finished sent by the webpage control is received by the first client. In the above-mentioned technical solutions, by displaying the reference page on the first client, the blank page on the screen can be avoided, and the continuity of the page display is improved.

In some embodiments, the page content sending unit is further configured to fill the first page content by the webpage control into a webpage frame of the first page frame view to acquire the first page view.

In some embodiments, the page display control apparatus further includes a page rendering unit, a page integrating unit and a page displaying unit. The page rendering unit is configured to trigger the webpage control to acquire a second description file of second rendering information corresponding to a second page based on presence of the second page corresponding to the first page, parse the second description file to acquire second page rendering information, and perform page view rendering according to the second page rendering information to acquire a second page frame view. The second page is a sub-page of the first page, and the second page frame view represents a webpage frame of the second page. The page integrating unit is configured to acquire a second page content from a server in response to receiving a second page display instruction, and trigger the webpage control to acquire a second page view by integration according to the second page frame view and the second page content. The second page content represents a webpage interactive content that is interactive with the first client in the second page, and the second page display instruction is generated in response to the second page being triggered. The page displaying unit is configured to display the second page view.

In some embodiments, the page integrating unit is further configured to acquire the second page content from the server in response to receiving the second page display instruction and the second page content being not stored in the webpage control.

In some embodiments, the page integrating unit is further configured to invoke a common gateway interface of the server to acquire through the common gateway interface the second page content uploaded to the server by a second client.

In some embodiments, the reference page displaying unit is further configured to acquire a pre-stored reference page from an internal storage in response to receiving the first page display instruction, and display the reference page. The reference page is at least one selected from a dynamic page and a static page.

In some embodiments, a rendering instruction sending unit is configured to send a page rendering instruction to the webpage control to trigger the webpage control to acquire a first description file of first rendering information corresponding to the first page, parse the first description file to acquire first page rendering information, and perform page view rendering according to the first page rendering information to acquire the first page frame view.

Regarding the apparatus in the above-mentioned embodiments, the specific manner in which each module performs the operation has been described in detail in the embodiments of the method, which will not be described in detail here.

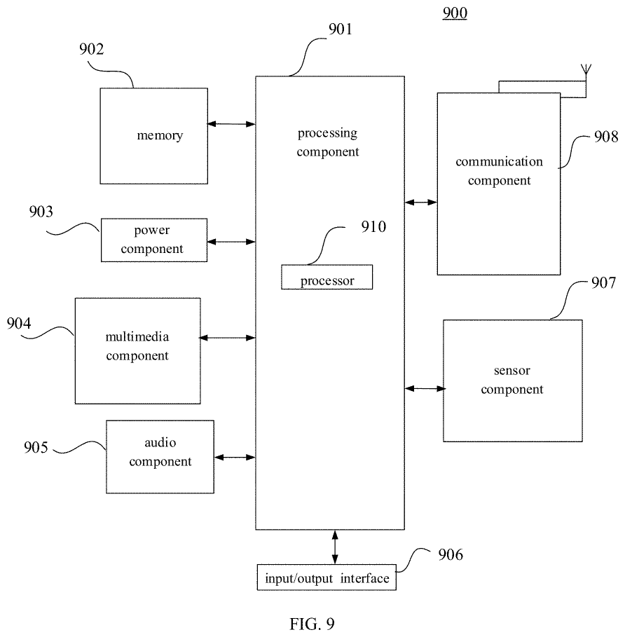

FIG. 9 is a block diagram of a device 900 for displaying a page according to an embodiment. For example, the device 900 may be a client. Referring to FIG. 9, the device 900 may include one or more of the following components: a processing component 901, a memory 902, a power component 903, a multimedia component 904, an audio component 905, an input/output (I/O) interface 906, a sensor component 907, and a communication component 908.

The processing component 901 typically controls overall operations of the device 900, such as operations associated with display, telephone calls, data communications, camera operations, and recording operations. The processing component 901 may include one or more processors 910 to execute instructions to perform all or part of the operations in the above described method. Moreover, the processing component 901 may include one or more modules which facilitate interaction between the processing component 901 and other components. For instance, the processing component 901 may include a multimedia module to facilitate interaction between the multimedia component 904 and the processing component 901.

The memory 902 is configured to store various types of data to support the operation of the device 900. Examples of such data include instructions for any applications or methods operated on the device 900, contact data, phonebook data, messages, pictures, videos, etc. The memory 902 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 903 provides power to various components of the device 900. The power component 903 may include a power management system, one or more power sources, and any other components associated with the generation, management, and distribution of power in the electronic device 900.

The multimedia component 904 includes a screen providing an output interface between the device 900 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 904 includes a front camera and/or a rear camera. The front camera and the rear camera may receive external multimedia data while the device 900 is in an operation mode, such as a photographing mode or a video mode. Each of the front camera and the rear camera may be a fixed optical lens system or have focus and optical zoom capability.

The audio component 905 is configured to output and/or input audio signals. For example, the audio component 905 includes a microphone (MIC) configured to receive an external audio signal when the device 900 is in an operation mode, such as a call mode, a recording mode, and a voice recognition mode. The received audio signal may be further stored in the memory 902 or transmitted via the communication component 908. In some embodiments, the audio component 905 further includes a speaker to output audio signals.

The I/O interface 906 provides an interface between the processing component 901 and a peripheral interface module, such as a keyboard, a click wheel, buttons, and the like. The buttons may include, but are not limited to, a home button, a volume button, a starting button, and a locking button.

The sensor component 907 includes one or more sensors to provide status assessments of various aspects of the device 900. For instance, the sensor component 907 may detect an open/closed status of the device 900, relative positioning of components, e.g., the display and the keyboard, of the device 900, a change in position of the device 900 or a component of the device 900, a presence or absence of user contact with the device 900, an orientation or an acceleration/deceleration of the device 900, and a change in temperature of the device 900. The sensor component 907 may include a proximity sensor configured to detect a presence of nearby objects without any physical contact. The sensor component 907 may also include a light sensor, such as a CMOS or CCD image sensor, for use in imaging applications. In some embodiments, the sensor component 907 may also include an accelerometer sensor, a gyroscope sensor, a magnetic sensor, a pressure sensor, or a temperature sensor.

The communication component 908 is configured to facilitate communication, wired or wireless, between the device 900 and other devices. The device 900 may access a wireless network based on a communication standard, such as WiFi, an operator network (such as 2G, 3G, 4G or 5G) or a combination thereof. In one exemplary embodiment, the communication component 908 receives a broadcast signal or broadcast associated information from an external broadcast management system via a broadcast channel. In one exemplary embodiment, the communication component 908 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the electronic device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In some embodiments, there is also provided a non-transitory computer-readable storage medium including instructions, such as the memory 902 including instructions, executable by the processor 910 in the device 900, for performing the above-described methods. For example, the non-transitory computer-readable storage medium may be a read-only memory (ROM), a random access memory (RAM), a CD-ROM, a magnetic tape, a floppy disc, an optical data storage device, and the like.

According to a fifth aspect of embodiments in the present disclosure, there is provided a computer program product. The program product includes a computer program, and the computer program is stored in a readable storage medium. When the computer program is read from the readable storage medium and executed by at least one processor of a device, the device is configured to perform the page display control method in the above-mentioned embodiments.

Other embodiments of the present disclosure will be apparent to those skilled in the art from consideration of the specification and practice of the present disclosure disclosed herein. The present disclosure is intended to cover any variations, uses, or adaptive modifications of the present disclosure following the general principles thereof and including common general knowledge or conventional techniques in the art not disclosed by this disclosure. It is intended that the specification and examples be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A page display control method, applied to a first client, comprising:
receiving a first page display instruction;
displaying a reference page stored in the first client;
sending a first page content to a webpage control in response to receiving a page acquisition request sent by the webpage control, wherein the first page content represents a webpage interactive content that is interactive with the first client in the first page, acquiring a first page view by the webpage control through integration according to a first page frame view and the first page content, and returning information that page rendering is finished by the webpage control; and
hiding the reference page and displaying the first page view in response to receiving the information that the page rendering is finished.

2. The page display control method according to claim 1, wherein said acquiring the first page view by the webpage control through the integration according to the first page frame view and the first page content comprises:
filling the first page content by the webpage control into a webpage frame of the first page frame view to acquire the first page view.

3. The page display control method according to claim 1, further comprises:
trigging the webpage control to acquire a second description file of second rendering information corresponding to a second page based on presence of the second page corresponding to the first page, parsing the second description file to acquire second page rendering information, and performing page view rendering according to the second page rendering information to acquire a second page frame view, wherein the second page is a sub-page of the first page, and the second page frame view represents a webpage frame of the second page;
acquiring a second page content from a server in response to receiving a second page display instruction, and triggering the webpage control to acquire a second page view by integration according to the second page frame view and the second page content, wherein the second page content represents a webpage interactive content that is interactive with the first client in the second page, and the second page display instruction is generated in response to the second page being triggered; and
displaying the second page view.

4. The page display control method according to claim 3, wherein said acquiring the second page content from the server in response to receiving the second page display instruction comprises:
acquiring the second page content from the server in response to receiving the second page display instruction and the second page content being not stored in the webpage control.

5. The page display control method according to claim 4, wherein said acquiring the second page content from the server comprises:
invoking a common gateway interface of the server to acquire through the common gateway interface the second page content uploaded to the server by a second client.

6. The method according to claim 1, wherein said displaying the reference page stored in the first client in response to receiving the first page display instruction comprises:
acquiring a pre-stored reference page from an internal storage in response to receiving the first page display instruction, and displaying the reference page, wherein the reference page is at least one selected from a dynamic page and a static page.

7. The page display control method according to claim 1, further comprising: sending a page rendering instruction to the webpage control, comprising:
sending the page rendering instruction to the webpage control to trigger the webpage control to acquire a first description file of first rendering information corresponding to the first page, parsing the first description file to acquire first page rendering information, and performing page view rendering according to the first page rendering information to acquire the first page frame view.

8. An electronic device, comprising:
a processor;
a memory for storing instructions executable by the processor;
wherein the processor is configured to execute the instructions to perform following operations:
receiving a first page display instruction;
displaying a reference page stored in a first client;
sending a first page content to a webpage control in response to receiving a page acquisition request sent by the webpage control, wherein the first page content represents a webpage interactive content that is interactive with the first client in the first page, acquiring a first page view by the webpage control through integration according to a first page frame view and the first page content, and returning information that page rendering is finished by the webpage control; and
hiding the reference page and displaying the first page view in response to receiving the information that the page rendering is finished.

9. The electronic device according to claim 8, wherein the processor is configured to execute the instructions to perform:
filling the first page content by the webpage control into a webpage frame of the first page frame view to acquire the first page view.

10. The electronic device according to claim 8, wherein the processor is configured to execute the instructions to perform:
triggering the webpage control to acquire a second description file of second rendering information corresponding to a second page based on presence of the second page corresponding to the first page, parsing the second description file to acquire second page rendering information, and performing page view rendering according to the second page rendering information to acquire a second page frame view, wherein the second page is a sub-page of the first page, and the second page frame view represents a webpage frame of the second page;
acquiring a second page content from a server in response to receiving a second page display instruction, and triggering the webpage control to acquire a second page view by integration according to the second page frame view and the second page content, wherein the second page content represents a webpage interactive content that is interactive with the first client in the second page, and the second page display instruction is generated in response to the second page being triggered; and
displaying the second page view.

11. The electronic device according to claim 10, wherein the processor is configured to execute the instructions to perform:
acquiring the second page content from the server in response to receiving the second page display instruction and the second page content being not stored in the webpage control.

12. The electronic device according to claim 11, wherein the processor is configured to execute the instructions to perform following operations:
invoking a common gateway interface of the server to acquire through the common gateway interface the second page content uploaded to the server by a second client.

13. The electronic device according to claim 8, wherein the processor is configured to execute the instructions to perform following operations:
acquiring a pre-stored reference page from an internal storage in response to receiving the first page display instruction, and displaying the reference page, wherein the reference page is at least one selected from a dynamic page and a static page.

14. The electronic device according to claim 8, wherein the processor is configured to execute the instructions to perform:
sending a page rendering instruction to the webpage control to trigger the webpage control to acquire a first description file of first rendering information corresponding to the first page, parsing the first description file to acquire first page rendering information, and performing page view rendering according to the first page rendering information to acquire the first page frame view.

15. A non-transitory computer-readable storage medium having stored therein instructions that, in response to being executed by a processor of an electronic device, cause the electronic device to perform the following operations:
receiving a first page display instruction;
displaying a reference page stored in a first client;
sending a first page content to a webpage control in response to receiving a page acquisition request sent by the webpage control, wherein the first page content represents a webpage interactive content that is interactive with the first client in the first page, acquiring a first page view by the webpage control through integration according to a first page frame view and the first page content, and returning information that page rendering is finished by the webpage control; and
hiding the reference page and displaying the first page view in response to receiving the information that the page rendering is finished.

16. The non-transitory computer-readable storage medium according to claim 15, wherein based on that the instructions in the storage medium are executed by the processor of the electronic device, the electronic device is further configured to perform:
filling the first page content by the webpage control into a webpage frame of the first page frame view to acquire the first page view.

17. The non-transitory computer-readable storage medium according to claim 15, wherein based on that the instructions in the storage medium are executed by the processor of the electronic device, the electronic device is further configured to perform:
triggering the webpage control to acquire a second description file of second rendering information corresponding to a second page based on presence of the second page corresponding to the first page, parsing the second description file to acquire second page rendering information, and performing page view rendering according to the second page rendering information to acquire a second page frame view, wherein the second page is a sub-page of the first page, and the second page frame view represents a webpage frame of the second page;
acquiring a second page content from a server in response to receiving a second page display instruction, and triggering the webpage control to acquire a second page view by integration according to the second page frame view and the second page content, wherein the second page content represents a webpage interactive content that is interactive with the first client in the second page, and the second page display instruction is generated in response to the second page being triggered; and
displaying the second page view.

18. The non-transitory computer-readable storage medium according to claim 17, wherein based on that the instructions in the storage medium are executed by the processor of the electronic device, the electronic device is further configured to perform:
in response to receiving the second page display instruction and the second page content being not stored in the webpage control, acquiring the second page content from the server, optionally invoking a common gateway interface of the server to acquire through the common gateway interface the second page content.

19. The non-transitory computer-readable storage medium according to claim 15, wherein based on that the instructions in the storage medium are executed by the processor of the electronic device, the electronic device is further configured to perform:
acquiring a pre-stored reference page from an internal storage in response to receiving the first page display instruction, and displaying the reference page, wherein the reference page is at least one selected from a dynamic page and a static page.

20. The non-transitory computer-readable storage medium according to claim 15, wherein based on that the instructions in the storage medium are executed by the processor of the electronic device, the electronic device is further configured to perform:
sending a page rendering instruction to the webpage control to trigger the webpage control to acquire a first description file of first rendering information corresponding to the first page, parsing the first description file to acquire first page rendering information, and performing page view rendering according to the first page rendering information to acquire the first page frame view.
